(19) United States
(12) Patent Application Publication
(10) Pub. No.: US 2009/0273597 A1
(43) Pub. Date: Nov. 5, 2009

(54) USER INTERFACE SCREEN LAYOUT ANALYSIS USING HIERARCHICAL GEOMETRIC FEATURES

(75) Inventors: Kashyap K. Chatamballi, Bangalore (IN); Tal Drory, Haifa (IL); Amir Geva, Yokneam (IL); Eugeniusz Walach, Haifa (IL)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/115,018

(22) Filed: May 5, 2008

(51) Int. Cl. G06F 17/00

(52) U.S. Cl. 345/418

(57) ABSTRACT

A technique is disclosed for the performance of application software “screen layout” testing analysis by designation of “fiduciary blocks” (e.g., words, boxes etc.) to serve as geometrical features for identification of data fields of interest viewed within a graphical user interface (GUI) screen. The set of designated “geometric fiduciary blocks” is then assembled into a “hierarchical structure” to analyze test results involving the data fields contained within each block.

### FIELD OF THE INVENTION

The present invention relates generally to automating computer program user interfaces (including graphical user interface (GUI) screen layouts) using hierarchical geometric features.

### BACKGROUND

A large part of the total cost and resources spent in undertaking a computer software development process may be incurred due to testing, requiring use of automated software testing tools. Automated application testing is a process where a series of predefined actions are performed on a software application program undergoing development, such as performing graphical user interface (GUI) “mouse clicks”, inputting information into data fields, and activating various user interface controls according to the protocol established for their use. The results of the testing are evaluated by comparing the processing state of the application program to a certain expected state after performance of the test(s).

In order to test an application, state of the art testing software must often “instrument” (i.e., modify or insert “spy code”) into the application program in a way that allows the testing software to directly access the programming structure and processing state of the tested application. Through this access, the actions described above are performed and the processing state (i.e., value(s) of data fields, status of checkboxes, etc.) is compared against expected result(s). For this type of access, evaluating or (“reading”) the application processing state does not require visually assessing (or “looking” at”) the GUI interface (or “window”) to be viewed by the user of the software application, but rather reading the tested data values using internal program variables. For example, in a query form (such as a “search” text box), the testing software inserts values into the form field(s) and then submits the query to compare the returned result field(s) with a set of preset values that indicate whether the test was successful.

The prior art approach of accessing the tested software application program through “instrumentation” (i.e., modification of the software) is problematic for various reasons, including that:
It requires knowledge of the tested software
It is time consuming, since it requires a developer to create new programming interfaces for the software
Some “closed” software is not accessible in this manner
Changing the application software (for the purposes of testing) may affect its behavior in an unintended way

In order to complement this “instrumentation” approach, a “visual” approach may also be used in which the tested software application is accessed through its GUI interface. In this method, the GUI window of the tested software application is “captured” and analyzed in order to evaluate its processing state. This analysis usually involves:
Image processing to recognize graphic screen features such as lines, rectangles and circles in order to deduce user interface controls (such as fields, check boxes etc.)
Optical Character Recognition (OCR) to retrieve text (such as titles, field text, etc.)

This approach works well as long as the OCR program can provide perfect recognition results to correctly identify all data/text fields of interest. However, optical character recognition will occasionally fail so alternative screen analysis methods are often needed. One problem experienced with use of OCR programs involves application “internationalization” where the program structure of the application software remains the same, but text labels for data fields may change with use of various different languages and alphabets. (For example, languages that do not use the Latin alphabet may pose a problem involving more than interpreting and translating text, since this may require recognition of additional type faces and/or alphabetic characters.) Other examples exist where relying solely on optical character recognition may pose a problem.

### BRIEF SUMMARY

The purpose of this invention is to provide a complimentary approach to conventional OCR-based methods of retrieving text when GUI “window capture” methods are used in application software testing. However, the concepts covered by the invention can be utilized in multiple computer processing domains including, for example:
Automation of business processes performed by human operators
Automation of access to legacy systems for the purpose of data migration
Automation of software testing

The preferred embodiment illustrated below follows the software testing domain as an example, although the other examples described above can also make use of the concepts provided in this disclosure.

In accordance with at least one presently preferred embodiment of the present invention, there is broadly contemplated herein a technique for automating computer program user interfaces (including graphical user interface (GUI) screen layouts) using hierarchical geometric features. More particularly, the invention provides a complimentary approach to conventional optical character recognition (OCR) based methods of retrieving text when GUI “window capture” methods are used in application software testing.

The invention discloses the performance of application software “screen layout” testing analysis by designation of “fiduciary blocks” (e.g., words, boxes etc.) to serve as geometrical features for identification of data fields of interest viewed within a graphical user interface (GUI) screen. The set of designated “geometric fiduciary blocks” is then assembled into a “hierarchical structure” to analyze test results involving the data fields contained within each block. This approach of using a set of designated “fiduciary blocks” automates the majority of test script creation and simplifies the GUI testing process considerably.

In summary, one aspect of the invention provides a computer system comprised of a computer processor configured for executing program instructions stored in computer memory and arranged for automating a user interface by using hierarchical geometric features for processing a visual data output, the system comprising: (a) an arrangement for analyzing visual data elements to build a hierarchical description of multiple elements in geometrical relationship to each other; (b) an arrangement for partitioning the user interface into geometric regional areas using the hierarchical description; and (c) an arrangement for searching for a match between a described data element and the geometrically partitioned user interface structure.

Another aspect of the invention provides a method of automating a user interface in a computer system using hierarchical geometric features for processing a visual data output, the method comprising the steps of: (a) analyzing visual data elements to build a hierarchical description of multiple elements in geometrical relationship to each other; (b) partitioning the user interface into geometric regional areas using the hierarchical description; and (c) searching for a match between a described data element and the geometrically partitioned user interface structure.

Furthermore, an additional aspect of the invention provides a computer program storage device readable by a computer processor machine, tangibly embodying a program of instructions executable by the machine to perform a method of automating a user interface in a computer system using hierarchical geometric features for processing a visual data output, the method comprising the steps of: (a) analyzing visual data elements to build a hierarchical description of multiple elements in geometrical relationship to each other; (b) partitioning the user interface into geometric regional areas using the hierarchical description; and (c) searching for a match between a described data element and the geometrically partitioned user interface structure.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 schematically illustrates a computer system with which a preferred embodiment of the present invention can be used.

FIG. 2 illustrates a graphical user interface (GUI) screen display with which a preferred embodiment of the present invention can be used.

FIGS. 3 and 4 illustrate “layout tree(s)” that partition a GUI screen display into hierarchical geometric regional areas in one embodiment of the present invention.

### DETAILED DESCRIPTION

A description of example embodiments of the invention follows.

For a better understanding of the present invention, together with other and further features and advantages thereof, reference is made to the following description, taken in conjunction with the accompanying drawings, and the scope of the invention will be pointed out in the appended claims.

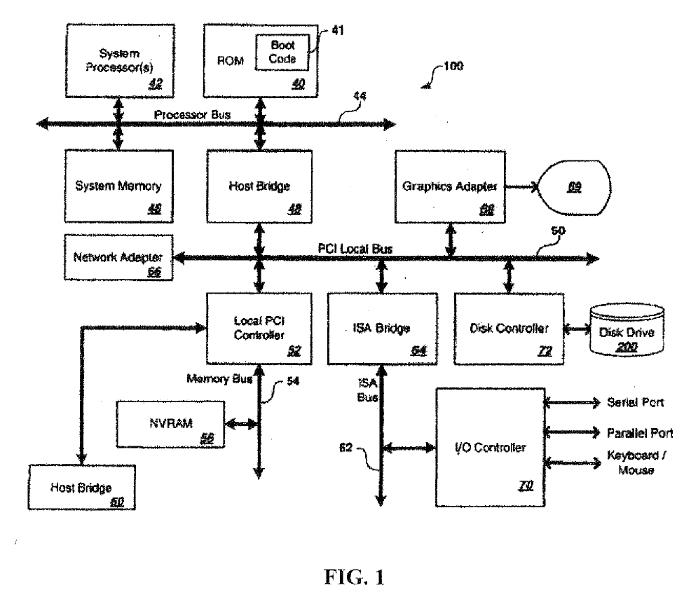

It will be readily understood that the components of the present invention, as generally described and illustrated in the Figures herein, may be arranged and designed in a wide variety of different configurations. Thus, the following more detailed description of the embodiments of the apparatus, system, and method of the present invention, as represented in FIGS. 1-4, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

Referring now to FIG. 1, there is depicted a block diagram of an illustrative embodiment of a computer system 100. The illustrative embodiment depicted in FIG. 1 may be a notebook computer system, such as one of the ThinkPad® series of personal computers previously sold by the International Business Machines Corporation of Armonk, N.Y., and now sold by Lenovo (US) Inc. of Morrisville, N.C.; however, as will become apparent from the following description, the present invention is applicable to any data processing system. Notebook computers, as may be generally referred to or understood herein, may also alternatively be referred to as “notebooks”, “laptops”, “laptop computers” or “mobile computers”.

As shown in FIG. 1, computer system 100 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to a local area network (LAN), and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a keyboard and mouse. In addition, I/O controller 70 supports external communication by computer system 100 via serial and parallel ports, including communication over a wide area network (WAN) such as the Internet. A disk controller 72 is in communication with a disk drive 200 for accessing external memory. Of course, it should be appreciated that the system 100 may be built with different chip sets and a different bus structure, as well as with any other suitable substitute components, while providing comparable or analogous functions to those discussed above.

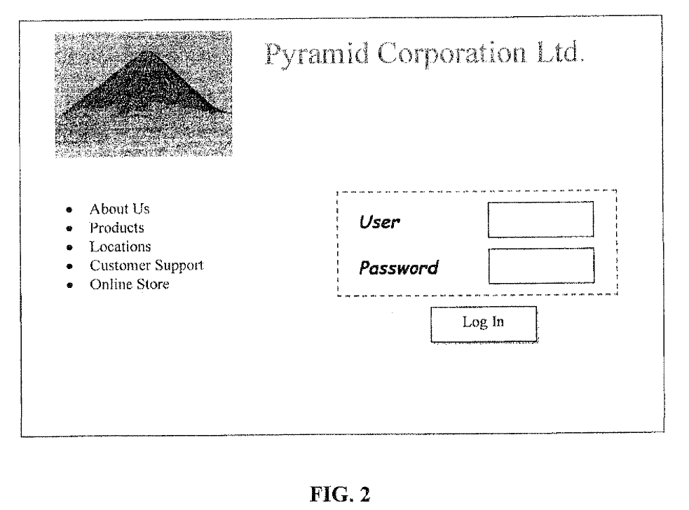

In the example software application illustrated in FIG. 2, the GUI region of interest 10 for testing is a “user login” field marked by a dashed line. To test the “user login” process, the automated testing program performs a procedure to populate (or “fill in”) the “user” and “password” text fields and then activate the mouse to “click” the “log in” button. Using optical character recognition (and/or another visual approach), the label(s) ‘user’ and ‘password’ are recognized along with rectangular box(es) on their right indicating their respective text field(s). Access to the appropriate text field 11 can then be accomplished by referring to the label 12 on its left. Internal OCR software logic associates a label in the vicinity of a text field using normal GUI conventions (usually but not limited to on the left or top of the field).

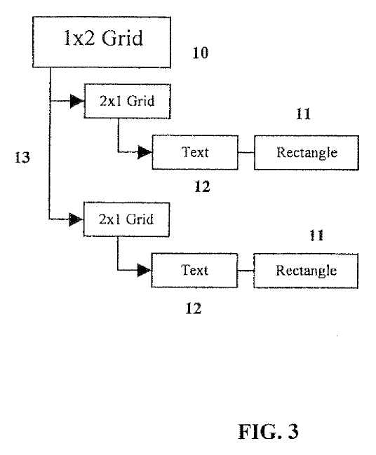

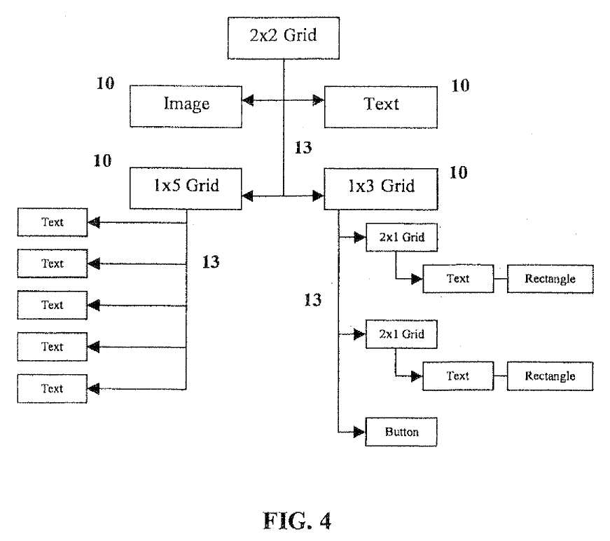

Using the concepts disclosed by the present invention, if the OCR software fails to correctly recognize a text box label, the data field 11 corresponding to the label 12 is described by its geometric relationship to other GUI screen elements. For example, access to the “password” field is made by reference to the “bottom right” field in the structure illustrated in FIGS. 2 and 3 during test script composition. During “run time” execution, the testing software analyzes the GUI screen components 10 in order to build a hierarchical description of all screen image elements in geometrical relationship to each other, i.e., to create a “layout tree” that partitions the entire screen into geometric regional areas (or “fiduciary blocks”) 13 containing GUI controls, as illustrated in FIGS. 3 and 4. The testing software then searches for a match between the data field structure described in the test script and the geometrically partitioned screen structure. When a match is found, the software identifies the correct field to be tested even if its corresponding text label cannot be accurately read using optical character recognition (OCR).

This technique can be used independent of the OCR-based approach or GUI testing can be accomplished by using either (or both) approaches in conjunction with each other. In cases where multiple geometric sections on the screen match the data field structure(s) being queried, a combination of the two approaches can be applied in a way that the final resolution is accomplished by comparing the queried text with partial OCR results.

In a possible programming technique for implementing the invention, the test script executes a request to access a data field structure 11 by including a hierarchical geometric description of the region of interest 13 that contains the field to be accessed, for example accessing the ‘password’ field shown in FIG. 2 using the following programming structure:

<row>
<text hint=”user”/>
<rectangle id=”name”/>
</row>
<row>
<text hint—”password”/>
<rectangle id=”pass”/>
</row>

The purpose of the “hint value” in the description is to allow integration with the OCR approach by matching that value (being searched for) against the partial OCR results available for that screen component. The purpose of the “id value” is to assign a name for the item to be accessed (for reference purposes).

Upon execution, the testing software will attempt to locate a subset of values in the geometric hierarchy that matches the request, using an algorithm that for example includes:
A definition of a distance metric between two geometric structures (to determine any dissimilarity between two descriptions)
A search function that looks for a minimum distance between a geometric structure and the queried structure (where a match is found if the minimum distance is below a certain threshold)

The testing software analyzes a GUI “screen capture” by collecting the geometric features detected in the image 10 such as that shown in FIG. 2 (including text, rectangles, lines, circles, etc.) to construct a hierarchical description of all these features by building a “partitioning tree” 13 (using for example the following programming technique for building a hierarchy) such as that shown in FIGS. 3 and 4:

<grid>
<row>
<image/>
<text value=”Pyramid Corporation Ltd”/>
</row>
<row>
<textblock>
About Us
Products
Locations
Customer Support
Online Store
</textblock>
<grid>
<row>
<text/>
<rectangle size=”. .
</row>
<row>
<text/>
<rectangle size=”. .
</row>
<row>
<button text=”Log In”/>
</row>
</ grid>
</row>
</ grid>

In a case where the result of the search for the described geometric structure provides multiple matching areas, a way to resolve the ambiguity integrates the hierarchical approach with the OCR approach by using the “hints” provided in the description to find the best match with partial OCR results. An alternate way to solve this problem is to describe some type of dimensional relationship between multiple similar regions, for example:
An approximate direction vector between the two regions (e.g., describing one region as being located to the right/left of the other)
A size relation (e.g., selecting the largest of the regions)
Some other discernible feature (such as text length in the data fields, colors, etc.)

Creation of a query description implementing the above techniqu(es) can be performed manually (such as by editing the extensible markup language (XML) description of a screen element) or by creating a geometric structure description through direct use of the “screen capture” analysis software (thereby allowing a user to record GUI interface actions and transform them into queries to be performed later).

It is to be understood that the present invention, in accordance with at least one presently preferred embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodies in the medium.

Any combination of one or more usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local are a network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operations of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustration, can be implemented by special purpose hardware-based systems that perform the specified functions or acts, or combinations of special purpose hardware and computer instructions.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of automating a user interface in a computer system using hierarchical geometric features for processing a visual data output, the method comprising:
analyzing visual data elements to build a hierarchical description of multiple elements in geometrical relationship to each other;
partitioning the user interface into geometric regional areas using the hierarchical description; and
searching for a match between a described data element and the geometrically partitioned user interface structure.

2. The method of claim 1 wherein the computer system is used to perform application software testing analysis by designation of graphical or textual data elements to serve as geometrical features for identification of tested data fields viewed within a graphical user interface screen.

3. The method of claim 2 wherein testing software constructs a hierarchical description of the geometric features by building a partitioning tree.

4. The method of claim 3 wherein the testing software locates a set of values in the geometric hierarchy that matches a tested data field by:
defining a distance between two geometric structures; and
searching for a distance between a geometric structure and the tested data field that is below a threshold value.

5. The method of claim 1 wherein optical character recognition is also used to retrieve textual data elements located within the user interface structure.

6. The method of claim 5 wherein multiple geometric regions match a described data element that is located by comparison with partial optical character recognition results.

7. The method of claim 6 wherein a dimensional relationship is defined between multiple similar geometric regions by using at least one of:
a direction between two regions;
a size comparison between two regions;
a data field text length comparison between two regions; or
a color comparison between two regions.

8. The method of claim 5 wherein the described data element is located when it cannot be accurately identified using optical character recognition.

9. A computer system comprised of a computer processor configured for executing program instructions stored in computer memory and arranged for automating a user interface by using hierarchical geometric features for processing a visual data output, the system comprising:
an arrangement for analyzing visual data elements to build a hierarchical description of multiple elements in geometrical relationship to each other;
an arrangement for partitioning the user interface into geometric regional areas using the hierarchical description; and
an arrangement for searching for a match between a described data element and the geometrically partitioned user interface structure.

10. The system of claim 9 wherein the computer system is used to perform application software testing analysis by designation of graphical or textual data elements to serve as geometrical features for identification of tested data fields viewed within a graphical user interface screen.

11. The system of claim 10 wherein testing software constructs a hierarchical description of the geometric features by building a partitioning tree.

12. The system of claim 11 wherein the testing software locates a set of values in the geometric hierarchy that matches a tested data field by:
defining a distance between two geometric structures; and
searching for a distance between a geometric structure and the tested data field that is below a threshold value.

13. The system of claim 9 wherein optical character recognition is also used to retrieve textual data elements located within the user interface structure.

14. The system of claim 13 wherein multiple geometric regions match a described data element that is located by comparison with partial optical character recognition results.

15. The system of claim 14 wherein a dimensional relationship is defined between multiple similar geometric regions by using at least one of:
a direction between two regions;
a size comparison between two regions;
a data field text length comparison between two regions; or
a color comparison between two regions.

16. The system of claim 13 wherein the described data element is located when it cannot be accurately identified using optical character recognition.

17. A computer program storage device readable by a computer processor machine, tangibly embodying a program of instructions executable by the machine to perform a method of automating a user interface in a computer system using hierarchical geometric features for processing a visual data output, the method comprising the steps of:
analyzing visual data elements to build a hierarchical description of multiple elements in geometrical relationship to each other;
partitioning the user interface into geometric regional areas using the hierarchical description; and
searching for a match between a described data element and the geometrically partitioned user interface structure.
